(19) United States
(12) Patent Application Publication
(10) Pub. No.: US 2007/0220802 A1
(43) Pub. Date: Sep. 27, 2007

(54) Laterally flexible bird track with reduced extension

(76) Inventor: Bruce Donoho, Mission Viejo, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/386,241

(22) Filed: Mar. 21, 2006

(51) Int. Cl. A01M 23/38

(52) U.S. Cl. 43/98

(57) ABSTRACT

An animal deterring device has at least two conductive tracks mounted onto elevated portions of a carrier, wherein the carrier comprises multiple repeat units that are coupled to each other to allow side-to-side flexibility while reducing, or even completely eliminating longitudinal extension of the device.

### FIELD OF THE INVENTION

The field of the invention is animal deterrents, and especially as they relate to bird deterrents.

### BACKGROUND OF THE INVENTION

Among numerous other known animal deterring devices using electric current, those in which two or more conductive traces are mounted to an elevated carrier are advantageous from various perspectives. For example, the elevated position of the traces typically reduces, and in some cases even prevents short-circuiting of the device where heavy rain or snow is encountered.

A typical device with elevated conductive traces is known from U.S. Pat. No. 6,283,064. Here, a non-conductive strip has two sidewalls with horizontal mounting tabs extending therefrom, and a crown portion onto which the traces are coupled in a raised position. From a top view, the non-conductive strip has an undulating configuration that advantageously allows for side-to-side deformation. While such devices provide several advantages over other known devices, various difficulties remain. Most significantly, such devices are prone to lengthwise stretching and will typically remain deformed once stretched. To overcome problems associated with stretching, non-linearly extensible connectors can be attached to the device as described in U.S. Pat. No. 6,928,768. Here a restraint member is attached along the length of the deterrent device to avoid deformation. While such arrangement will typically reduce stretching to at least some degree, several new problems arise. Among other things, the restraint member must be coupled to the device, which significantly increases cost of manufacture. Moreover, and at least in some instances, the restraint member will reduce side-to-side flexibility of the device.

Therefore, while there are numerous devices and methods for deterring animals, and especially birds are known in the art, all or almost all of them suffer from various disadvantages. Thus, there is still a need for new configurations and methods for bird deterrents.

### SUMMARY OF THE INVENTION

The present invention is directed to configurations and methods for animal, and especially bird deterring devices in which electrically conductive traces are mounted on elevated portions of a carrier, and in which the carrier has a configuration that reduces, or even entirely eliminates longitudinal extension of the device.

In one aspect of the inventive subject matter, contemplated devices have first and second elevated carrier rails to which first and second conductive traces are coupled, respectively, in which each of the rails comprises a plurality of repeat units, wherein each repeat unit comprises a carrier unit having an outer wall, an inner wall, and a crown portion, and wherein each repeat unit further comprises a gap. Preferably, the ratio between the smallest longitudinal dimension of the inner wall and the length of the gap is at least 3.5, and even more preferably at least 5.0.

Especially contemplated devices include those in which the repeat units has a longitudinal dimension of between 1 cm and 5 cm, and/or in which the gap has a longitudinal dimension of between 1 mm and 6 mm. most typically, the first and second elevated carrier rails are coupled to each other at lower edges of the respective inner walls, and at least one of the conductive traces has a crimped portion. Where desired, at least one of the carrier rails may include a mounting tab.

In another aspect of the inventive subject matter, contemplated devices include a first elevated carrier rail coupled to a second elevated carrier rail, wherein each of the rails comprises a plurality of repeat units, and wherein each repeat unit comprises a carrier unit having an outer wall, an inner wall, and a crown portion, and wherein each repeat unit further comprises a gap. In such devices, it is generally preferred that the inner wall and the gap are configured such that the device has a maximum gap elongation of 50%, more preferably 30%, and most preferably 20% when the device is extended using manual force.

Typically, the inner wall of such devices has a shortest longitudinal dimension of at least 80% of longitudinal dimension of the repeat unit, and further includes a first and a second conductive track that are coupled to the first and second rail, respectively. The rails in most of such devices will be fabricated from a synthetic polymer, while the first and second conductive tracks comprise a metal wire, which typically includes a crimped portion.

Viewed from a different perspective, contemplated devices will comprise a stripe-shaped carrier having an M-shaped vertical cross sectional profile formed by opposing inner sidewalls and outward facing sidewalls, wherein the inner sidewalls are coupled to each other at their lower portions such that the device is substantially non-extendible in longitudinal direction most typically, such devices will include one or more cutouts extending though at least the outward facing sidewalls to form a plurality of gaps, wherein the gaps are preferably configured to allow side-to-side deformation of the device. In preferred embodiments, the gaps extend into an opposing inner sidewall no more than 10% of the height of the inner sidewall. Preferably, two or more conductive tracks are coupled to a first and second crown portion of the M-shape, and one or more mounting tabs may be coupled to the outward facing sidewalls.

Various objects, features, aspects and advantages of the present invention will become more apparent from the following detailed description of preferred embodiments of the invention.

### BRIEF DESCRIPTION OF THE DRAWING

Prior Art FIG. 1 is a top view of a known device having elevated rails.

FIG. 2 is a top view of one exemplary device according to the inventive subject matter.

FIG. 3 is a detail view of the device of FIG. 2.

FIG. 4 is an elevated front view of a vertical cross section of the device of FIG. 2.

### DETAILED DESCRIPTION

The inventor has discovered that an animal, and especially a bird deterring device can be manufactured in which at least two electrically conductive traces are mounted on a carrier in an elevated position, wherein the device is substantially non-extendible in longitudinal direction.

It should be appreciated that animal deterring devices are often exposed to significant environmental impact (e.g., high winds, significant temperature changes, etc.), which frequently results in longitudinal extension of such devices from which heretofore known devices would not entirely recover and thus detach from the surface to which they were mounted. One exemplary known device is depicted in Prior Art FIG. 1A in which the device 100 has a first elevated rail 110A that is coupled to a second elevated rail 110B. A typically crimped conductive wire 120A, 120B is attached to the crown portion of the rails, and the device is then affixed to a roof, ledge, or other structure using mounting tabs 112A. Arrow 150A depicts the smallest longitudinal dimension of an inner wall.

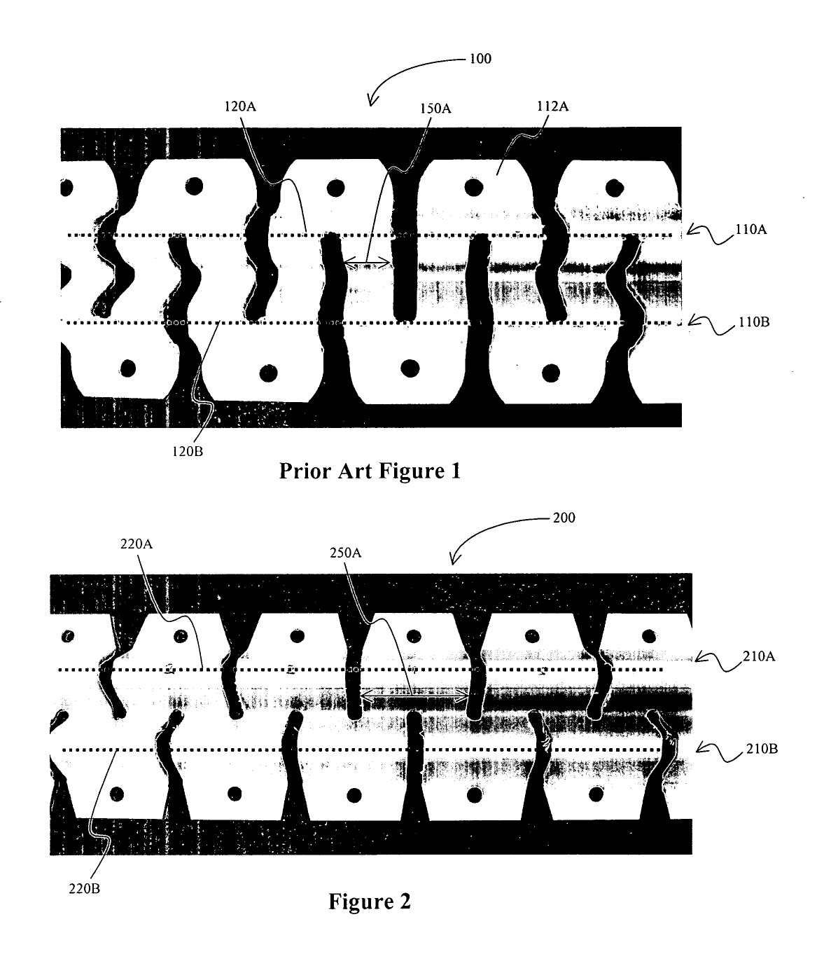

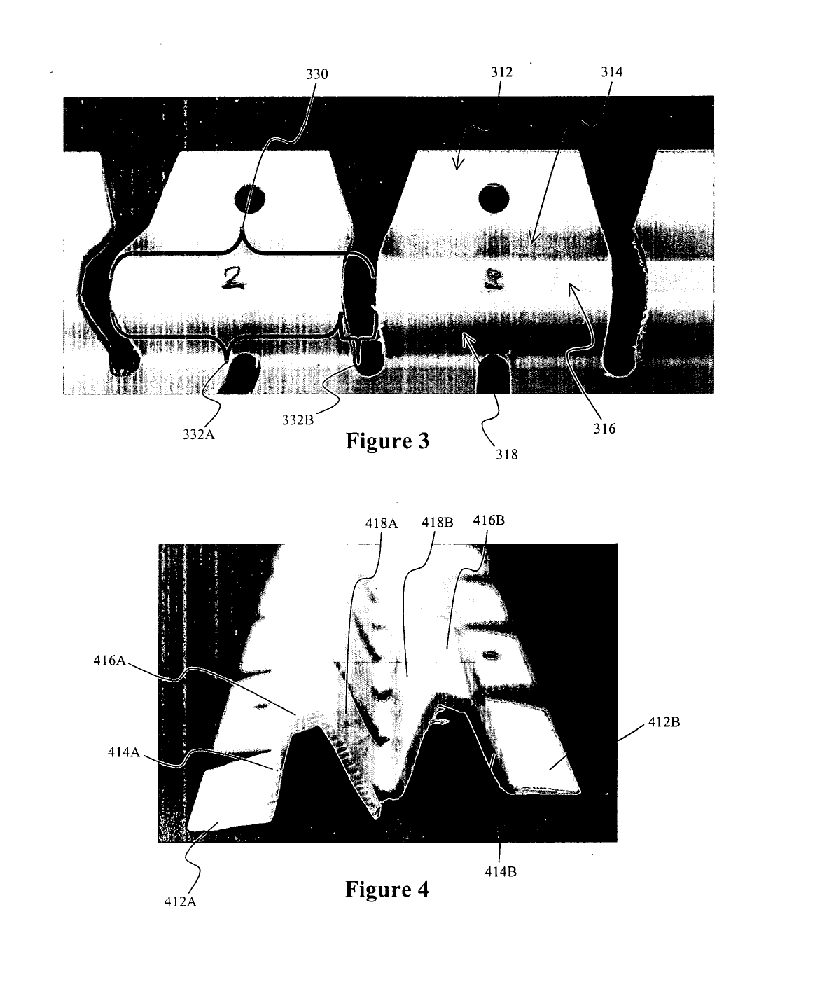

In contrast, as depicted in FIG. 2, a deterrent device 200 has a first elevated rail 210A that is coupled to a second elevated rail 210B, each carrying crimped conductive wires 220A and 220B, respectively. Arrow 250A depicts the smallest longitudinal dimension of an inner wall. FIG. 3 depicts in more detail the device of FIG. 2. As can be seen, each of the rails comprises a plurality of repeating units 330, each of which comprises a carrier unit 332A and a gap 332B. Each carrier unit typically includes an inner wall 318, a crown portion 316, and an outer wall 314, to which a mounting tab 312 is coupled. In most preferred aspects, two adjacent repeat units of one rail are coupled to each other using an inner wall of another repeat unit in the opposing rail. Thus, it should be appreciated that the gap extends only between the carrier units of one rail, but does not extend (or only insignificantly) into the inner wall of the opposing carrier unit. Such arrangement provides remarkable resistance to longitudinal extension.

FIG. 4 depicts an elevated vertical cross sectional view of the device of FIG. 3, in which (from left to right) the device is fabricated from a mounting tab 412A that is coupled to an outside wall 414A. Continuous with the outer wall is crown portion 416A carrying a conductive trace (not shown). The crown portion is then coupled to the inner wall 418A, which is coupled to the inner wall 418B of the opposing rail. Crown portion 416B is coupled to outside wall 414B, which is coupled to mounting tab 412B. Most typically, two inner walls of one rail are coupled to one inner wall of the opposing rail using the entire inner wall of the opposing rail. Viewed from a different perspective, the gap between two repeat units of one rail will typically not extend (or if so, then typically less than 20%, more typically less than 10% of the inner wall) into the inner wall of a repeat unit of an opposing rail. It should be especially appreciated that such coupling of opposing rails and/or repeat units to each other is particularly advantageous as such coupling effectively eliminates longitudinal stretch in contemplated devices. FIG. 1 illustrates heretofore known coupling in which neither rail nor inner walls form a continuous longitudinal structure that would prevent stretching in longitudinal direction. In contrast, as depicted in FIG. 2, rail 210A and 210B have a substantially continuous longitudinal structure in which a stretching force on one rail is counterbalanced by the inner wall of the opposing inner wall of a repeat unit.

It is generally preferred that the devices according to the inventive subject matter include at least one, and more typically two elevated carrier rails, wherein the elevation is typically at least 3 mm, more typically at least 5 mm, and most typically at least 1 cm relative to the surface to which the device is coupled. Therefore, contemplated devices will typically have an overall width of between 1 cm and 15 cm, and more typically between 2 cm and 6 cm. Suitable heights of contemplated devices will be in most cases between 5 mm and 5 cm, and most preferably between 1 cm and 3 cm. With respect to the longitudinal dimension, it is preferred that the devices according to the inventive subject matter are at least 20 cm, more typically at least 60 cm, and most typically at least 120 cm long. However, significantly longer devices are also contemplated. The thickness of suitable materials for the rails, tabs, and other structures is typically between 0.01 mm to several cm, but most preferably between 1 mm and 3 mm.

It is generally preferred that the carrier rails, mounting tabs, and/or other elements of contemplated devices are made from a non-conductive material, and most preferably from a synthetic polymer (e.g., polyethylene, polycarbonate, polyvinyl chloride, polystyrene, etc.), and that such devices are either molded or extruded (in which case the gaps will be formed in a downstream production step). Where the device is at least partially formed from a conductive material, isolating portions are generally preferred that separate the electric charge in a rail and/or conductive trace from a second conductive trace or rail and/or surface onto which the rail is mounted. Mounting tabs are preferably provided to each carrier of a repeat unit, however, less frequent mounting tabs are also deemed suitable. Moreover, numerous other mounting options are also contemplated and include mating connectors with a mounting rail, central mounting bores, etc., so long as the contemplated devices can be affixed to a surface without destruction of the device, and especially without disruptions of the conductive traces.

With respect to the repeat units it is generally preferred that the repeat units are uniform in size and configuration, however, non-uniform repeat units are not excluded. Most typically, the repeat unit will have a longitudinal dimension of between 1 cm and 5 cm., but longer repeat units are also contemplated and include those between 5 cm and 25 cm, and even those between 25 cm and 100 cm and more. Depending on the particular shape of contemplated devices, the configuration of a repeat unit and/or carrier unit may vary considerably, and all possible shapes are deemed suitable so long as such shapes provide at least one elevated basis for at least one conductive trace. However, in especially preferred embodiment, the carrier unit will have an outer wall and an inner wall that support a crown portion. Most typically, the walls and the crown portion are continuous and the crown portion may be in a position other than horizontal (when installed on a horizontal surface) to facilitate fluid runoff. In still further preferred aspects, the vertical cross section of a device according to the inventive subject matter is generally M-shape Therefore, the walls and the crown are at angles other than 90 and 180 degrees relative to an absolute horizontal plane.

Preferred gaps generally extend in longitudinal direction between 1 mm and 6 mm, but wider gaps are not excluded (especially where the carrier portions are relatively long. It is further generally preferred that the gap extends to the base portion where the inner walls of opposing rails are coupled to each other, but fail to significantly extend into the opposing inner wall (or if so, then less than 20%, more typically less than 10%, most typically less than 5% of the opposing inner wall width). Moreover, and especially where the device includes a plurality of mounting tabs, the gaps are preferably configured to allow side-to-side deformation of the device.

Carrier portions will most preferably have a continuous inner wall with a longitudinal dimension larger than the vertical dimension. Typically, the smallest longitudinal dimension of the inner wall is between one or more millimeters and several centimeters, and even longer. More critically, the ratio between the smallest longitudinal dimension of the inner wall and the length of the gap is at least 3.5, more typically at least 4.0, even more typically at least 5.0, and most typically at least 6.0. Viewed from a different perspective, it should be recognized that the inner wall of a repeat unit will have a shortest longitudinal dimension of at least 70%, more typically at least 75%, even more typically at least 80%, and most typically at least 85% of the longitudinal dimension of the repeat unit. Furthermore, it is generally preferred that the carrier and/or repeat units of the first and second rail are in an offset position. Most preferably, the gap in one rail is centrally opposed to the inner wall of the inner wall of a repeat unit of the other rail. First and second elevated carrier rails are preferably coupled to each other at the lower edges of the respective inner walls to thereby form a V- or U-shaped profile. However, horizontal or otherwise configured spacers between the elevated rails are also deemed suitable.

Remarkably, contemplated devices have a surprising and significant resistance toward longitudinal elongation, and under most circumstances (e.g., where the rail is predominantly formed from a synthetic polymer [e.g., PE] having thickness of between 1 and 2 mm, and width as measured between the outer ends of the outer wall of between 2 to 5 cm) exhibit a maximum gap elongation of 50%, more typically maximum gap elongation of 30%, and most typically maximum gap elongation of 20% when the device is extended using manual force. In contrast, the same manual force exerted upon a device according to Prior Art FIG. 1 will typically result in a gap elongation of at least 200%. Gap elongation can be measured, for example, by placing a 30 cm strip of contemplated devices on a horizontal surface, manually engaging the device at both ends, and pulling the ends of the device apart using a force typically associated with de-corking a wine bottle.

First and second conductive traces are typically spaced apart and positioned on the crown portion at a distance that allows formation of an electric circuit when a foot of a bird (e.g., an adult pigeon, an adult seagull) rests on the device. Therefore, and depending on the particular bird, suitable distances between first and second traces will be between 5 mm and 2 cm, and more typically between 7 mm and 1.5 cm. In most preferred aspects, first and second conductive traces are generally parallel, and/or at least one of the first and second conductive traces is continuous along substantially (+/−5%) the entire length of the carrier. To accommodate side-to-side motion, and to increase exposure of the conductive trace to the environment, the conductive traces will preferably, but not necessarily have a crimped portion. Moreover, and where desired, the conductive traces may also be mounted on the wall or walls of the carrier portions.

Therefore, contemplated animal deterring devices will typically include those in which a stripe-shaped carrier has an M-shaped vertical cross sectional profile formed by opposing inner sidewalls and outward facing sidewalls, wherein the inner sidewalls are coupled to each other at their lower portions such that the device is substantially non-extendible (i.e., overall extension of less than 5%, more typically less than 2.5% when the device is extended using manual force) in longitudinal direction. However, numerous other shapes are also considered suitable so long as they provide at least one elevated carrier. With respect to the gaps in such devices, it is preferred that the gaps (cutouts) extend though at least the outward facing sidewalls to form a plurality of gaps. Most typically, however, the gaps will not extend into the opposing inner sidewall. Similar to the considerations provided above, the gaps will preferably be configured to allow side-to-side deformation of the device.

Thus, specific embodiments and applications of electrified animal repellent tracks have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. An animal deterring device comprising:
a first and a second elevated carrier rail to which a first and a second conductive trace are coupled, respectively, wherein each of the rails comprises a plurality of repeat units;
wherein each repeat unit comprises a carrier unit having an outer wall, an inner wall, and a crown portion, and wherein each repeat unit further comprises a gap; and
wherein a ratio between a smallest longitudinal dimension of the inner wall and a length of the gap is at least 3.5.

2. The device of claim 1 wherein the ratio is at least 5.0.

3. The device of claim 1 wherein the repeat units has a longitudinal dimension of between 1 cm and 5 cm.

4. The device of claim 1 wherein the gap has a longitudinal dimension of between 1 mm and 6 mm.

5. The device of claim 1 wherein the first and second elevated carrier rails are coupled to each other at lower edges of the respective inner walls.

6. The device of claim 1 wherein at least one of the conductive traces has a crimped portion.

7. The device of claim 1 wherein at least one of the carrier rails includes a mounting tab.

8. An animal deterring device comprising:
a first elevated carrier rail coupled to a second elevated carrier rail, wherein each of the rails comprises a plurality of repeat units;
wherein each repeat unit comprises a carrier unit having an outer wall, an inner wall, and a crown portion, and wherein each repeat unit further comprises a gap; and
wherein the inner wall and the gap are configured such that the device has a maximum gap elongation of 50% when the device is extended using manual force.

9. The animal deterring device of claim 8 wherein the maximum gap elongation is 30%.

10. The animal deterring device of claim 8 wherein the maximum gap elongation is 20%.

11. The animal deterring device of claim 8 wherein the inner wall has a shortest longitudinal dimension of at least 80% of longitudinal dimension of the repeat unit.

12. The animal deterring device of claim 8 further comprising a first and a second conductive track that are coupled to the first and second rail, respectively.

13. The animal deterring device of claim 8 wherein the first and second rail are fabricated from a synthetic polymer.

14. The animal deterring device of claim 8 wherein the first and second conductive track comprise a crimped portion.

15. An animal deterring device comprising a stripe-shaped carrier having an M-shaped vertical cross sectional profile formed by opposing inner sidewalls and outward facing sidewalls, wherein the inner sidewalls are coupled to each other at their lower portions such that the device is substantially non-extendible in longitudinal direction.

16. The device of claim 15 wherein the device has cutouts extending though at least the outward facing sidewalls to form a plurality of gaps.

17. The device of claim 16 wherein the gaps are configured to allow side-to-side deformation of the device.

18. The device of claim 15 wherein the gaps extend into an opposing inner sidewall no more than 10% of the height of the inner sidewall.

19. The animal deterring device of claim 15 further comprising a first and a second conductive track that is coupled to a first and second crown portion of the M-shape.

20. The animal deterring device of claim 15 further comprising a plurality of mounting tabs coupled to the outward facing sidewalls.
